(19) United States
(12) Patent Application Publication
(10) Pub. No.: US 2026/0221132 A1
(43) Pub. Date: Jul. 30, 2026

(54) AUGMENTING DEEP NEURAL NETWORKS WITH RESIDUAL MEMORIZATION

(71) Applicant: GOOGLE LLC, Mountain View, CA (US)

(72) Inventors: Zitong Yang, Mountain View, CA (US); Michal Mateusz Lukasik, New York, NY (US); Vaishnavh Nagarajan, New York, NY (US); Zonglin Li, Secaucus, NJ (US); Ankit Singh Rawat, New York, NY (US); Manzil Zaheer, West New York, NJ (US); Aditya Krishna Menon, New York, NY (US)

(21) Appl. No.: 19/149,046

(22) PCT Filed: Jan. 26, 2024
(86) PCT No.: PCT/US2024/013222

§ 371 Date: Jul. 17, 2025

Related U.S. Application Data
(60) Provisional application No. 63/441,405, filed on Jan. 26, 2023.

(51) Int. Cl. G10L 15/16; G06V 10/82

(52) U.S. Cl. CPC G10L 15/16; G06V 10/82

(57) ABSTRACT

Methods, systems, and apparatus, including computer programs encoded on a computer storage medium, for performing a machine learning task. In particular, the machine learning task is performed by augmenting a trained neural network with residual memorization.

### CROSS-REFERENCE TO RELATED APPLICATION

This application claims the benefit of U.S. Provisional Application No. 63/441,405, filed on Jan. 26, 2023, which is incorporated herein by reference.

### BACKGROUND

This specification relates to a system that processes a network input using a neural network to generate a network output to perform a task.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current values of a respective set of parameters.

### SUMMARY

This specification describes a neural network system implemented as computer programs on one or more computers in one or more locations that is configured to perform a machine learning task. The neural network system includes a deep neural network and a residual regressor that performs residual memorization.

The subject matter described in this specification can be implemented in particular embodiments so as to realize one or more of the following advantages.

Unlike existing methods that have tried to increase the size of a neural network model (e.g., increasing the number of parameters) to improve memorization of the model, which would significantly increase the cost of model training and serving, i.e., of performing inference on new inputs using the model, the techniques described in this specification improve both memorization and generalization of a neural network model without increasing the model size.

In particular, compared to the implicit memorization performed by conventional large neural network models, the described neural network system can perform explicit memorization via a separate regressor component that performs explicit memorization by accessing memorized residuals between the predictions of the neural network and the ground truth outputs for training samples used to train the neural network.

Specifically, the described techniques allow a neural network system to predict a final network output for a network input by combining two components: (i) a predicted output generated by a deep neural network and (ii) an approximated residual output generated by a residual regressor that memorizes the model's residuals. Each residual measures an error between a sample output in a training sample and a predicted output generated by the deep neural network for the training sample.

As a result and compared to conventional prediction models, the described neural network system can have better inference-time performance and better inference-time generalization when performing supervised learning tasks, particularly when implicit memorization is infeasible, e.g., when the training data set is very large, or when the data patterns are too complex to learn perfectly.

In addition, the described techniques can improve the rate of convergence of the neural network system in comparison to conventional prediction models, thereby making training more computationally efficient, i.e., because fewer training steps are required for the model to achieve accurate performance on a given task. For example, because the regressor is used after inference, a neural network trained over fewer training steps can make use of the regressor to achieve comparable performance as the same neural network or even a larger neural network trained over a larger number of training steps.

Additionally, the described techniques allow a smaller, more computationally efficient neural network to attain a level of performance that matches that of a larger, less computationally efficient neural network that is not augmented with residual memorization. Thus, the described techniques are particularly suitable for implementation and deployment on devices with limited computational resources, such as mobile devices and edge devices. Where a large neural network cannot be deployed on a device, e.g. the device does not have enough memory to store the parameters of the large neural network, a smaller neural network augmented with residual memorization may be deployed instead. Alternatively, a smaller neural network with residual memorization may be deployed instead of a larger neural network to reduce memory consumption and latency whilst maintaining comparable performance. In other words, augmenting with residual memorization can have a lower memory footprint and lower additional latency than increasing the number of parameters of a neural network.

The details of one or more embodiments of the subject matter of this specification are set forth in the accompanying drawings, and the description below. Other features, aspects, and advantages of the subject matter will become apparent from the description, the drawings, and the claims.

### BRIEF DESCRIPTION OF THE DRAWINGS

FIG. 1 is a block diagram of an example neural network system.

FIG. 2 is an example of training the deep neural network and using the trained deep neural network and the residual regressor to perform inference.

FIG. 3 is a flow diagram of an example process for generating a final network output for a network input.

FIG. 4 shows an example of the performance of the described techniques relative to the performance of a deep neural network that does not use the residual regressor.

Like reference numbers and designations in the various drawings indicate like elements.

### DETAILED DESCRIPTION

This specification describes a neural network system implemented as computer programs on one or more computers in one or more locations that is configured to perform a machine learning task.

The neural network system can perform any kind of machine learning task, i.e., can be configured to receive any kind of digital data input and to generate any kind of score, classification, or regression output based on the input.

In some cases, the neural network system is configured to perform an image processing task, i.e., receive an input image and to process the input image, i.e., to process intensity values of the pixels of the image, to generate a network output for the input image. For example, the task may be image classification and the output generated by the neural network for a given image may be scores for each of a set of object categories, with each score representing an estimated likelihood that the image contains an image of an object belonging to the category. As another example, the task can be image embedding generation and the output generated by the neural network can be a numeric embedding of the input image. As yet another example, the task can be object detection and the output generated by the neural network can identify locations in the input image at which particular types of objects are depicted. As yet another example, the task can be image segmentation and the output generated by the neural network can assign each pixel of the input image to a category from a set of categories. As another example, the task can be a depth prediction task. In a depth prediction task, the output generated by the neural network identifies, for each pixel in the image, a predicted depth of the scene at the pixel. As yet another example, the task can be a surface normal prediction task. In a surface normal prediction task, the output generated by the neural network identifies, for each pixel in the image, a predicted surface normal of the scene at the pixel.

As another example, the neural network can be configured to perform a video processing task, where the neural network receives a video that includes a sequence of input images and processes the input images, i.e., process the intensity values of the pixels of the images, to generate a network output for the video. For example, the network output can be a classification output that includes a respective score for each of multiple categories, where the categories represent, e.g., topics of the video, object categories, or action categories that each correspond to possible actions that may be being performed by entities in the video, and each score represents an estimated likelihood that the video belongs to the category. As another example, the network output can identify optical flow between pixels of the images in the video. As another example, the network output can be one or more predicted images that are predicted to follow the last image in the sequence.

As another example, if the inputs to the neural network system are Internet resources (e.g., web pages), documents, or portions of documents or features extracted from Internet resources, documents, or portions of documents, the task can be to classify the resource or document, i.e., the output generated by the neural network system for a given Internet resource, document, or portion of a document may be a score for each of a set of topics, with each score representing an estimated likelihood that the Internet resource, document, or document portion is about the topic.

As another example, if the inputs to the neural network system are features of an impression context for a particular advertisement, the output generated by the neural network system may be a score that represents an estimated likelihood that the particular advertisement will be clicked on.

As another example, if the inputs to the neural network system are features of a personalized recommendation for a user, e.g., features characterizing the context for the recommendation, e.g., features characterizing previous actions taken by the user, the output generated by the neural network system may be a score for each of a set of content items, with each score representing an estimated likelihood that the user will respond favorably to being recommended the content item.

As one example, the task may be a neural machine translation task. For example, if the input to the neural network system is a sequence of text, e.g., a sequence of words, phrases, characters, or word pieces, in one language, the output generated by the neural network system may be a translation of the sequence of text into another language, i.e., a sequence of text in the other language that is a translation of the input sequence of text. As a particular example, the task may be a multi-lingual machine translation task, where a single neural network is configured to translate between multiple different source language-target language pairs. In this example, the source language text may be augmented with an identifier that indicates the target language into which the neural network system should translate the source language text.

As another example, the task may be an audio processing task. For example, if the input to the neural network system is a sequence representing a spoken utterance, e.g., a spectrogram or a waveform or features of the spectrogram or waveform, the output generated by the neural network system may be a piece of text that is a transcript for the utterance. As another example, if the input to the neural network system is a sequence representing a spoken utterance, the output generated by the neural network system can indicate whether a particular word or phrase (“hotword”) was spoken in the utterance. As another example, if the input to the neural network system is a sequence representing a spoken utterance, the output generated by the neural network system can identify the natural language in which the utterance was spoken.

As another example, the task can be a natural language processing or understanding task, e.g., an entailment task, a paraphrase task, a textual similarity task, a sentiment task, a sentence completion task, a grammaticality task, and so on, that operates on a sequence of text in some natural language.

As another example, the task can be a text to speech task, where the input is text in a natural language or features of text in a natural language and the network output is a spectrogram, a waveform, or other data defining audio of the text being spoken in the natural language.

As another example, the task can be a health prediction task, where the input is a sequence derived from electronic health record data for a patient and the output is a prediction that is relevant to the future health of the patient, e.g., a predicted treatment that should be prescribed to the patient, the likelihood that an adverse health event will occur to the patient, or a predicted diagnosis for the patient.

As another example, the task can be a text generation task, where the system receives a conditioning input and generates as output a sequence of text. For example, the conditioning input can be another sequence of text, e.g., so that the output sequence is a completion of the input sequence of text, a response to a question posed in the input sequence, or a sequence of text that is about a topic specified by the first sequence of text. As another example, the input to the text generation task can be an input other than text, e.g., an image, and the output sequence can be text that describes the input.

As another example, the task can be an image generation task, where the input is a conditioning input and the output is a sequence of intensity values for the pixels of an image.

As another example, the task can be a computer vision task, where the input is an image or a point cloud and the output is a computer vision output for the image or point cloud, e.g., a classification output that includes a respective score for each of a plurality of categories, with each score representing the likelihood that the image or point cloud includes an object belonging to the category.

When the input is an image or point cloud, the neural network system can include an embedding subnetwork that generates a respective embedding for each multiple patches of the image or point cloud, and the input to the first block of the neural network system can be a sequence that includes the respective embeddings (and, optionally, one or more additional embeddings, e.g., at a predetermined position that will later be used to generate the output). Each patch includes the intensity values of the pixels in a different region of the input image.

As another example, the task can be an agent control task, where the input is a sequence of observations or other data characterizing states of an environment and the output defines an action to be performed by the agent in response to the most recent data in the sequence. The agent can be, e.g., a real-world or simulated robot, a control system for an industrial facility, or a control system that controls a different kind of agent.

As another example, the task can be a genomics task, where the input is a sequence representing a fragment of a DNA sequence or other molecule sequence and the output is either an embedding of the fragment for use in a downstream task, e.g., by making use of an unsupervised learning technique on a data set of DNA sequence fragments, or an output for the downstream task. Examples of downstream tasks include promoter site prediction, methylation analysis, predicting functional effects of non-coding variants, and so on.

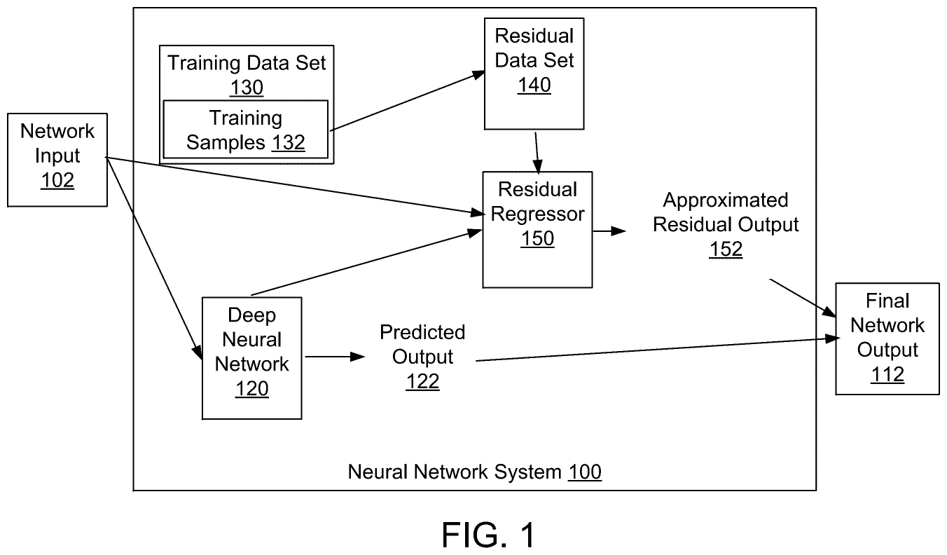

FIG. 1 is a block diagram of an example neural network system 100 that performs a given task, e.g., one of the tasks described above or a different task that requires processing network inputs to generate respective final network outputs for each of the network inputs.

The neural network system 100 is an example of a system implemented as computer programs on one or more computers in one or more locations in which the systems, components, and techniques described below are implemented.

In particular, to perform a task, the system 100 receives a new network input 102 and generates a final network output 112 for the task for the new network input 102.

To generate the final output 112, the system 100 processes the new network input 102 using a deep neural network 120 to generate a predicted output 122 for the new network input 102.

The deep neural network 120 has been trained to perform the task on a training data set 130.

The training data set 130 includes a plurality of training samples 132, each training sample having a respective sample input and a respective sample output, where the sample output is a ground truth, target output for the sample input for the machine learning task. That is, the sample output is the output that should be generated by performing the machine learning task on the sample input.

The deep neural network 120 is referred to as a “deep” neural network because the neural network includes multiple intermediate (“hidden”) layers in addition to an input layer and an output layer. The deep neural network 120 can generally have any appropriate architecture that can process inputs of the type required for the machine learning task and generate outputs of the type required for the machine learning task. For example, when the task requires processing images, the neural network 120 can be a Vision Transformer neural network or a convolutional neural network. As another example, when the task requires processing text, audio, or other sequential data, the neural network can be an encoder-decoder Transformer neural network, a decoder-only Transformer neural network, a recurrent neural network, or a different type of sequence processing neural network.

The system 100 or another training system can have trained the neural network 120 on the training samples 132 using any appropriate loss function for the machine learning task. For example, when the task is a classification task, the loss function can be a cross-entropy loss function or other appropriate classification loss function. When the task is a regression task, the loss function can be a mean-squared error loss function, a negative log likelihood loss function, or another appropriate regression loss function.

The system 100 maintains a residual data set 140 that associates, for each training sample 132, the sample input in the training sample with a residual output that measures an error between the sample output in the training sample 132 and a predicted output generated by the deep neural network 120 for the training sample 132.

The system 100 then processes the new network input 102 using a residual regressor 150 to generate an approximated residual output 152 for the new network input 102. The approximated residual output 152 is an approximation or, in other words, an estimate of the residual error between the predicted output 122 and the actual (unknown) output for the new network input 102 for the machine learning task given the residual data set 140. It will be understood that processing the new network input 102 can refer to processing an intermediate output generated by the neural network 110 by processing the network input 102, as will be described in more detail below.

In particular, the residual regressor 100 computes a respective weight for at least a subset of the residual outputs in the residual data set 140.

The residual regressor 150 then generates the approximated residual output 152 by computing a weighted sum of the subset of the residual outputs, in which each residual output in the subset is weighted by its respective weight.

The residual regressor 150 may be implemented using any suitable model for approximating the residual output 152.

The system 100 then combines the predicted output 122 and the approximated residual output 152 to generate the final network output 112 for the new network input 102.

Thus, the system 100 combines the output of a trained neural network with a residual output that is computed by making use of memorized residuals of the trained neural network.

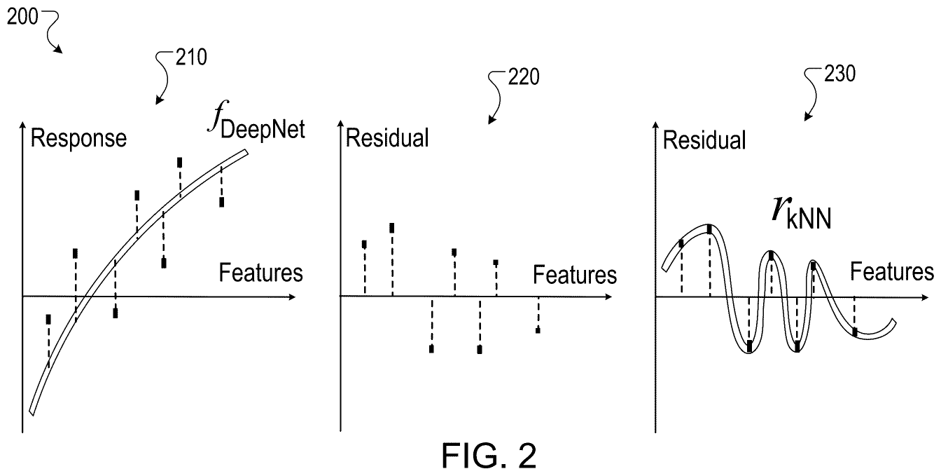

FIG. 2 shows the training of the deep neural network 120 and the use of the residual regressor 150 at inference time.

As shown in FIG. 2, the system 100 or another training system trains 210 the deep neural network 120 (f_{DeepNet}) to generate respective predicted outputs (“responses”) for each of the sample inputs (“features”).

The training system then computes 220, for each training sample, the residual between the predicted output (“response”) for the sample input in the training sample and the sample output for the training sample.

For example, when the task is a classification task, the system can compute the residual output rᵢ for training sample i in probability space as follows:

$${r}_{i} = onehot ( {y}_{i} ) - softmax ( \frac{{f}_{DeepNet} ( {x}_{i} )}{T} ) ,$$

where yᵢ is the target class for the sample input xᵢ in the training sample, f_{DeepNet}(xᵢ) is the predicted output for the sample input xᵢ, and Tis a hyperparameter that scales the “temperature” of the softmax function.

As another example, the system can compute the residual output rᵢ for training sample i in the logit space as follows:

$${r}_{i} = logit ( {y}_{i} ) - {f}_{DeepNet} ( {x}_{i} ) ,$$

where logit(yᵢ) is a target logit for the target class yᵢ in the training sample. The “logit space” of a neural network is the set of logits generated by the neural network, where the logits are the scores generated by the penultimate layer of the neural network, i.e., the layer before the softmax layer of the neural network. For example, the target logit can be the class mean for the target class.

For a regression task, the system can compute the residual output differently, e.g., as an element-wise error between corresponding elements of the predicted output and the sample output.

Thus, the residual outputs measure the error of the trained neural network on the training samples in the training data set. By persisting (storing) and making use of these residual outputs after training, the system incorporates explicit memorization into the inference process.

The system can also use the trained deep neural network 120 to generate a respective embedding of each of the sample inputs in each of the training samples. For example, the system can process each of the sample inputs using the trained deep neural network 120 offline to generate respective embeddings of each of the sample inputs. The embedding can be, e.g., the output of one or more of the intermediate layers of the trained deep neural network 120, i.e., as the output of a single intermediate layer or a combination, e.g., a concatenation or a sum or an average, of the outputs of two or more different intermediate layers.

The system 100 then performs inference 230 using the residuals for the training samples and the predicted outputs generated by the deep neural network 120.

In particular, when a new network input is received, the system 100 processes the new network input using the trained deep neural network 120 to generate a predicted output.

As part of processing the new network input using the trained deep neural network 120, the system 100 also generates an embedding of the new network input, e.g., as the output of one of the intermediate layers of the deep neural network 120.

The system 100 then uses the regressor 150 to generate a respective weight for each of the training samples in at least a subset of the training samples based on a similarity between the sample input in each training sample in the training sample and the new network input.

As a particular example, the system 100 can perform a search to identify the k closest sample inputs to the new network input, where the distance is measured based on similarities between the embedding of the new network input and the embeddings of the sample inputs. Generally, k is a fixed integer that is greater than 1 and governs how many training samples are considered by the regressor 150.

For example, the system can perform a k nearest neighbors search to identify the k embeddings of sample inputs that are most similar to the embedding of the new network input, e.g., based on l2 distance or inner product or another similarity measure.

As another example, when there are a large number of training samples, the system can perform an approximate k nearest neighbors search to identify k embeddings that approximate the k embeddings of sample inputs that are most similar to the embedding of the new network input, e.g., based on l2 distance or inner product or another similarity measure.

Once the subset of training samples have been identified, the system 100 can determine the respective weight for a given training sample based on a similarity between the embedding of the new network input and the embedding of the given sample input in the given training sample, i.e., as a function of the embedding of the new network input and the embedding of the given sample input.

For example, the system 100 can determine the respective weight wᵢ for a given training sample i as follows:

$${w}_{i} = exp ( - ‖ \tilde{z} - {z}_{i} ‖ / σ ) ,$$

where zᵢ is the embedding of the given sample input xᵢ, \tilde{z} is the embedding of the new network input \tilde{x}, and σ is a hyperparameter that controls the locality of the weights. That is, the system computes the weights in this manner for only the k largest weighs, i.e., the k closest training samples based on the similarity. For the remainder of the training samples, the weights are set to 0.

Thus, in this example, the function is an exponential of a second function of the difference between the new embedding and the embedding of the sample output corresponding to the residual output. In particular, the second function computes a norm (e.g., an L2 norm) of the difference and scales the norm by a scale factor determined by a hyperparameter.

Optionally, the system 100 can then generate a respective normalized weight w̅ᵢ for each training sample by normalizing the respective weights so that the weights sum to 1.

The system 100 can then predict an approximated residual output for the new network input from the weights for the training samples and the residual outputs for the training samples.

In particular, the system can generate an approximated residual output \tilde{r} for the new network input as follows:

$$\tilde{r} = {\sum }_{i = 1}^{k} {\overline{w}}_{i} {r}_{i} .$$

The system then combines the approximated residual output \tilde{r} for the new network input and the predicted output for the new network input to generate the final network output for the new network input.

For example, when the task is a classification task and the residual outputs are probabilities, the system can combine the outputs as follows:

$$softmax ( \frac{{f}_{DeepNet} ( \tilde{x} )}{T} ) + \tilde{r}$$

As another example, when the task is a classification task and the residual outputs are in the logit space, the system can combine the outputs as follows:

$$softmax ( \frac{{f}_{DeepNet} ( \tilde{x} ) + \tilde{r}}{T} )$$

As yet another example, when the task is a classification task and the residual outputs are in the logit space and the outputs are not required to be probabilities, the system can combine the outputs as follows:

$${f}_{DeepNet} ( \tilde{x} ) + \tilde{r} .$$

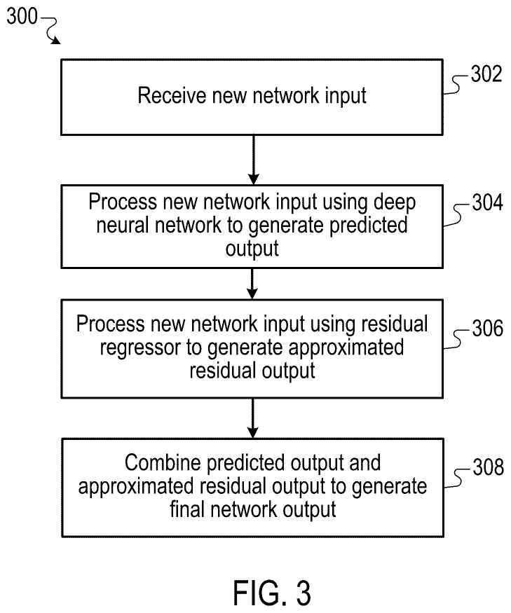

FIG. 3 is a flow diagram of an example process 300 for generating a final network output for a new network input. For convenience, the process 300 will be described as being performed by a system of one or more computers located in one or more locations. For example, a neural network system, e.g., the system 100 in FIG. 1, appropriately programmed in accordance with this specification, can perform the process 300.

The system receives a new network input (step 302).

The system processes the new network input using a deep neural network to generate a predicted output for the new network input (step 304).

The system processes the new network input using a residual regressor to generate an approximated residual output for the new network input (step 306).

As described above, the residual regressor generates the approximated residual output using a residual data set that associates, for each training sample in a set of training samples used to train the deep neural network, the sample input in the training sample with a residual output that measures an error between the sample output in the training sample and a predicted output generated by the deep neural network for the training sample.

Thus, the approximated residual output is an approximation of the residual between the predicted output and the actual ground truth output for the new network input (which may not be known).

As described above, processing the new network input can include processing an embedding of the new network input generated by the deep neural network.

The system combines the predicted output and the approximated residual output to generate the final network output for the new network input (step 308).

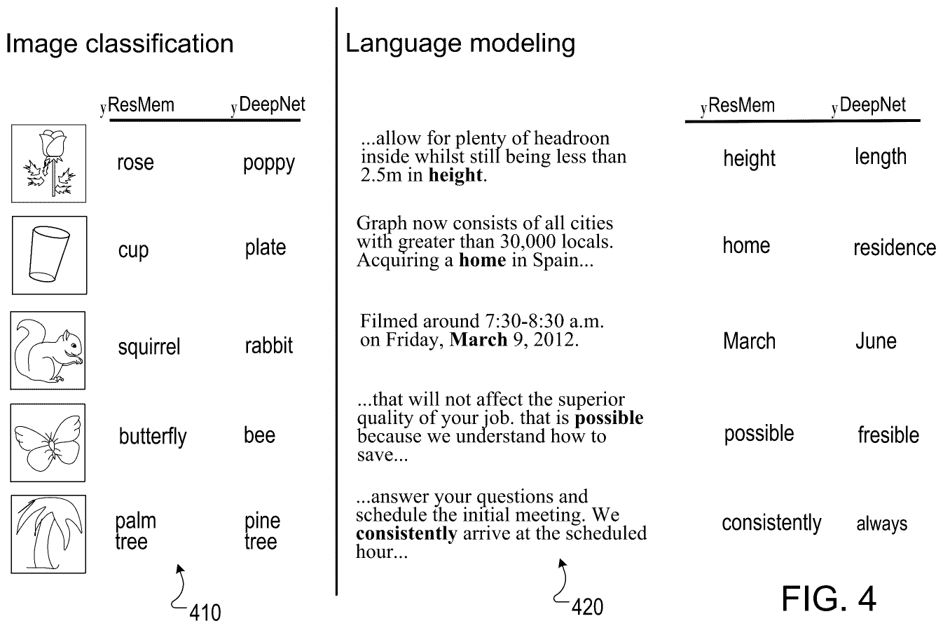

FIG. 4 shows examples of the performance of the described techniques. In particular, FIG. 4 shows examples of final network outputs y generated using the described techniques (ResMem) relative to final network outputs generated using only the predicted outputs of the deep neural network (DeepNet), i.e., final network outputs that are equal to the predicted outputs of the deep neural network.

More specifically, FIG. 4 shows examples 410 for an image classification task and examples 420 for a language modeling task.

As can be seen from the examples 410, making use of the described techniques can improve the predicted outputs generated by the deep neural network so that the outputs more accurately reflect the objects depicted in the input images.

As can be seen from the examples 420, making use of the described techniques can improve the predicted outputs generated by the deep neural network so that the outputs more accurately reflect the context provided by the remainder of the input text sequence.

Thus, by improving the accuracy of the generated outputs using residual memorization, the deep neural network can match or exceed the performance of a much larger, significantly less computationally efficient neural network on the corresponding machine learning task.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

In this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework or a Jax framework.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

This specification also provides the subject-matter of the following clauses:
Clause 1. A method for performing a task, the method comprising:
   receiving a new network input;
   generating a final network output for the new network input, wherein generating the final output comprises:
   processing the new network input using a deep neural network to generate a predicted output for the new network input;
   processing the new network input using a residual regressor to generate an approximated residual output for the new network input; and
   combining the predicted output and the approximated residual output to generate the final network output for the new network input.
Clause 2. The method of clause 1, wherein the deep neural network has been trained on a training data set to generate a predicted output for a given input, wherein the training data set comprises a plurality of training samples, each training sample having a sample input and a sample output.
Clause 3. The method of clause 2, further comprising: maintaining a residual data set that associates, for each training sample, the sample input in the training sample with a residual output that measures an error between the sample output in the training sample and a predicted output generated by the deep neural network for the training sample.
Clause 4. The method of clause 3, wherein processing the input using the residual regressor to generate an approximated residual output for the input comprises:
   for each residual output in the residual data set, computing a respective weight;
   wherein the residual regressor is configured to generate the approximated residual output by computing a weighted sum of at least a subset of residual outputs, wherein each residual output in the subset is weighted by its respective weight.
Clause 5. The method of clause 4, wherein computing the respective weight for each residual output comprises:
   computing the respective weight for each residual output based on a function of a new embedding and an embedding of the sample output corresponding to the residual output,
   wherein the new embedding is an output of one or more intermediate layers of the deep neural network during processing of the new input, and wherein the embedding of the sample output is another output of the one or more intermediate layers of the deep neural network during processing of the corresponding sample input.
Clause 6. The method of clause 5, wherein the function is an exponential of a second function of the difference between the new embedding and the embedding of the sample output corresponding to the residual output.
Clause 7. The method of clause 6, wherein the second function computes a norm of the difference and scales the norm by a scale factor determined by a hyperparameter.
Clause 8. The method of clause 7, wherein the norm is an L2 norm.
Clause 9. The method of any one of clauses 5-8, wherein among the respective weights computed for the residual outputs, only k largest weights are used to compute the weighted sum of at least the subset of residual outputs, the rest of weights are set to 0, wherein k is an integer greater than 1.
Clause 10. The method of any one of clauses 1-9, wherein the task is a classification task.
Clause 11. The method of clause 10, wherein the classification task is an image processing task, a speech recognition task, a natural language processing task, or an optical character recognition task.
Clause 12. The method of any one of clauses 1-9, wherein the task is a regression task.
Clause 13. A system comprising one or more computers and one or more storage devices storing instructions that, when executed by the one or more computers, cause the one or more computers to perform the operations of the respective method of any one of clauses 1-12.
Clause 14. One or more computer storage media storing instructions that, when executed by one or more computers, cause the one or more computers to perform the operations of the respective method of any one of clauses 1-12.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method for performing a task, the method comprising:
receiving a new network input;
generating a final network output for the new network input, wherein generating the final output comprises:
processing the new network input using a deep neural network to generate a predicted output for the new network input;
processing the new network input using a residual regressor to generate an approximated residual output for the new network input; and
combining the predicted output and the approximated residual output to generate the final network output for the new network input.

2. The method of claim 1, wherein the deep neural network has been trained on a training data set to generate a predicted output for a given input, wherein the training data set comprises a plurality of training samples, each training sample having a respective sample input and a respective sample output.

3. The method of claim 2, further comprising: maintaining a residual data set that associates, for each training sample, the sample input in the training sample with a residual output that measures an error between the sample output in the training sample and a predicted output generated by the deep neural network for the training sample.

4. The method of claim 3, wherein processing the input using the residual regressor to generate an approximated residual output for the input comprises:
for each of a subset of residual outputs in the residual data set, computing a respective weight,
wherein the residual regressor is configured to generate the approximated residual output by computing a weighted sum of the subset of residual outputs, wherein each residual output in the subset is weighted by its respective weight.

5. The method of claim 4, wherein computing the respective weight for each residual output comprises:
computing the respective weight for each residual output based on a function of a new embedding and an embedding of the sample output corresponding to the residual output,
wherein the new embedding is an output of one or more intermediate layers of the deep neural network during processing of the new input, and wherein the embedding of the sample output is another output of the one or more intermediate layers of the deep neural network during processing of the corresponding sample input.

6. The method of claim 5, wherein the function is an exponential of a second function of the difference between the new embedding and the embedding of the sample output corresponding to the residual output.

7. The method of claim 6, wherein the second function computes a norm of the difference and scales the norm by a scale factor determined by a hyperparameter.

8. The method of claim 7, wherein the norm is an L2 norm.

9. The method of claim 5, wherein the subset includes only k sample inputs that are most similar to the new network input according to a similarity search.

10. The method of claim 1, wherein the task is a classification task.

11. The method of claim 10, wherein the classification task is an image processing task, a speech recognition task, a natural language processing task, or an optical character recognition task.

12. The method of claim 1, wherein the task is a regression task.

13. A system comprising one or more computers and one or more storage devices storing instructions that, when executed by the one or more computers, cause the one or more computers to perform operations comprising:
receiving a new network input;
generating a final network output for the new network input, wherein generating the final output comprises:
processing the new network input using a deep neural network to generate a predicted output for the new network input;
processing the new network input using a residual regressor to generate an approximated residual output for the new network input; and
combining the predicted output and the approximated residual output to generate the final network output for the new network input.

14. The system of claim 13, wherein the deep neural network has been trained on a training data set to generate a predicted output for a given input, wherein the training data set comprises a plurality of training samples, each training sample having a respective sample input and a respective sample output.

15. The system of claim 14, wherein the operations further comprise:
maintaining a residual data set that associates, for each training sample, the sample input in the training sample with a residual output that measures an error between the sample output in the training sample and a predicted output generated by the deep neural network for the training sample.

16. The system of claim 15, wherein the operations for processing the input using the residual regressor to generate an approximated residual output for the input comprise:
for each of a subset of residual outputs in the residual data set, computing a respective weight,
wherein the residual regressor is configured to generate the approximated residual output by computing a weighted sum of the subset of residual outputs, wherein each residual output in the subset is weighted by its respective weight.

17. The system of claim 16, wherein the operations for computing the respective weight for each residual output comprise:
computing the respective weight for each residual output based on a function of a new embedding and an embedding of the sample output corresponding to the residual output,
wherein the new embedding is an output of one or more intermediate layers of the deep neural network during processing of the new input, and wherein the embedding of the sample output is another output of the one or more intermediate layers of the deep neural network during processing of the corresponding sample input.

18. The system of claim 17, wherein the function is an exponential of a second function of the difference between the new embedding and the embedding of the sample output corresponding to the residual output.

19. The system of claim 18, wherein the second function computes a norm of the difference and scales the norm by a scale factor determined by a hyperparameter.

20. One or more non-transitory computer-readable storage media storing instructions that, when executed by one or more computers, cause the one or more computers to perform operations comprising:
receiving a new network input;
generating a final network output for the new network input, wherein generating the final output comprises:
processing the new network input using a deep neural network to generate a predicted output for the new network input;
processing the new network input using a residual regressor to generate an approximated residual output for the new network input; and
combining the predicted output and the approximated residual output to generate the final network output for the new network input.
